(19) United States
(12) Patent Application Publication
(10) Pub. No.: US 2007/0039010 A1
(43) Pub. Date: Feb. 15, 2007

(54) Automatic generation of software code to facilitate interoperability

(75) Inventor: Makarand A. Gadre, Redmond, WA (US)

Correspondence Address: MICROSOFT CORPORATION;ATTN: PATENT GROUP DOCKETING DEPARTMENT, ONE MICROSOFT WAY, REDMOND, WA, 98052-6399, US

(73) Assignee: Microsoft Corporation, Redmond, WA (US)

(21) Appl. No.: 11/204,682

(22) Filed: Aug. 15, 2005

(51) Int. Cl. G06F 9/46

(52) U.S. Cl. 719/328

(57) ABSTRACT

Various technologies and techniques are disclosed that generate software code to enable or facilitate interoperability between native applications, such as Win32 applications written in C++, and framework applications, such as applications written based upon the MICROSOFT® .NET Framework. An interop code generator automatically creates a wrapper for enabling interoperability between a native application and a framework application.

### BACKGROUND

The enablement of software as a service may provide an integrated connection between information, people, systems, and devices. For example, the functionality of a software application may be shared across different devices, architectures, platforms, and programming languages.

Frameworks may facilitate such services. More specifically, frameworks may enable native application code originally developed for a target machine to run across different processor architectures and operating systems. Further, frameworks may accommodate source code developed in a variety of programming languages, thus combining benefits found in language integration, language independence, and platform independent computing.

While a number of applications today are being developed for framework environments, a large number of native applications still exist and will continue to exist in the future. These native applications need to be able to take advantage of the features offered by framework applications in a manner that does not require them to be re-written as a framework application. To enable a native application to communicate with framework applications, however, some type of wrapper function must be written. This typically requires a developer to manually inspect the source code of the framework application, write long wrapper functions around the procedures to expose the data types, or to describe each parameter's attributes, such as name, size, and type. The hand-crafted code must then be compiled so that it can be executed by the native application to communicate with the framework application.

To further complicate the foregoing procedures, each and every time there is a change to the code of the framework application, developers have to perform the whole process again by hand. Such redundant, manual processes may prove both tedious and error-prone.

### SUMMARY

Described herein are various technologies and techniques that generate software code to enable or facilitate interoperability between native application programs, such as source code developed for a single, target platform, and software code developed for scalable, distributed applications or frameworks. The native applications or source code may be selected from a variety of programming languages, such as C++. The framework may include, for example, the MICROSOFT® .NET Framework. In one aspect of the system, an interop code generator is used to automatically create a wrapper for enabling interoperability between a native application and a framework application.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a diagrammatic view of a computer system of one aspect of the present invention.

FIG. 2 is a diagrammatic view of an interop code generator operating on the computer system of FIG. 1 in one aspect of the present invention.

FIG. 3 is a high-level process flow diagram for one aspect of the system of FIG. 1 illustrating the stages involved in creating a wrapper for interoperability between a native application and a framework application.

FIG. 4 is a high-level process flow diagram for one aspect of the system of FIG. 1 illustrating the stages involved in creating a wrapper for interoperability between a native application and a MICROSOFT® .NET application.

FIG. 5 is a process flow diagram for one aspect of the system of FIG. 1 illustrating the more detailed stages performed by the interop code generator as introduced in FIG. 4.

FIG. 6 is a process flow diagram for one aspect of the system of FIG. 1 illustrating the stages involved in using a reflection procedure to retrieve information used by the interop code generator.

### DETAILED DESCRIPTION

For the purposes of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

Various native software programs, such as Win32 applications written in C++, need to be able to call software programs that were written in framework environments, such as applications written based upon the MICROSOFT® .NET Framework. In framework environments, a language abstraction layer typically uses a translator program to convert programs written in multiple source code languages (e.g. C#, J#, VB.NET) into a single intermediate language (IL). The framework typically further employs one or more compilers to compile the IL into an executable format required by the architecture of the particular device on which the program will be run. In one embodiment, the code is compiled from the intermediate language to a managed executable code just prior to runtime. Code running in such a framework environment is often referred to as managed code.

As described in further detail herein, in one aspect of the system, an interop code generator is used to automatically create a wrapper for enabling interoperability between a native application and a framework application.

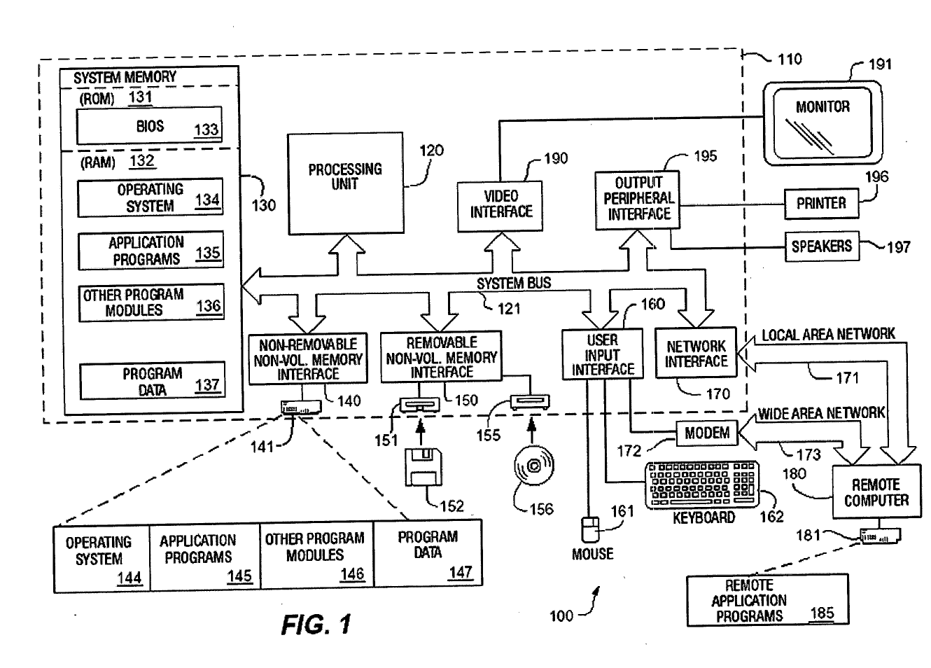

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through an non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through a output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

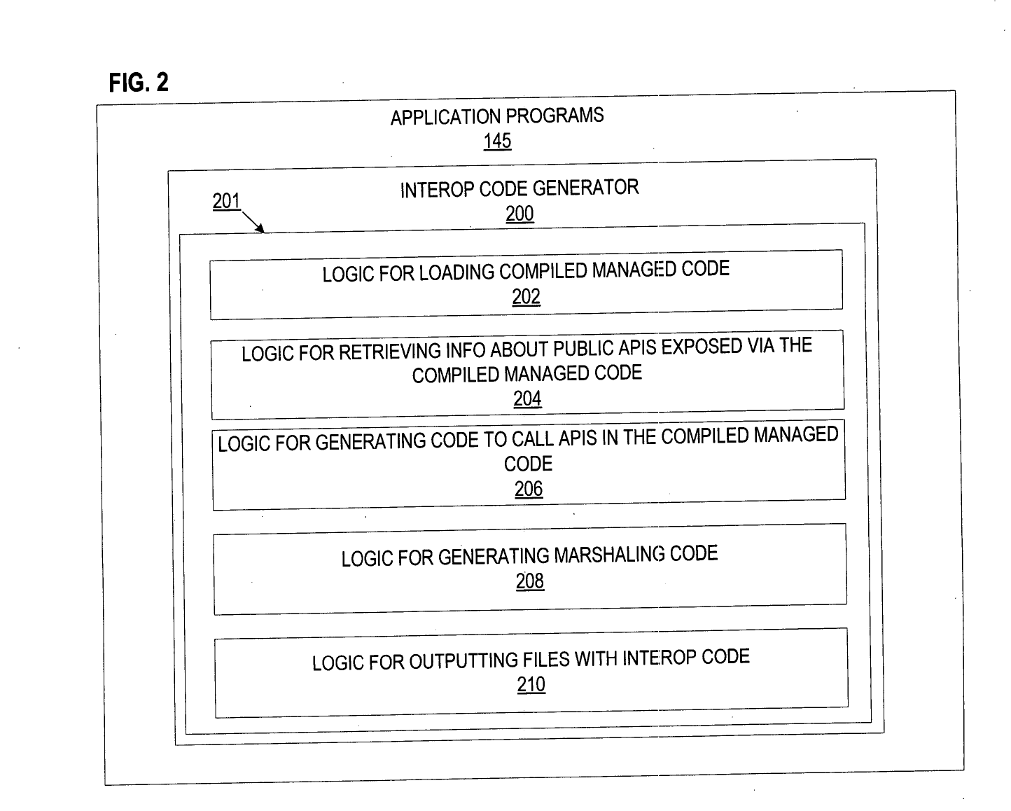

Turning now to FIG. 2 with continued reference to FIG. 1, an interop code generator 200 operating on computer 110 in one aspect of the present invention is illustrated. In the example illustrated on FIG. 2, interop code generator 200 is one of application programs 145 that reside on computer 110. Alternatively or additionally, one or more parts of interop code generator 200 can be part of application programs 135 in RAM 132, on remote computer 181 with remote application programs 185, or other such variations as would occur to one in the computer software art.

Interop code generator 200 includes business logic 201 that is responsible for carrying out some or all of the techniques described herein, such as for generating a wrapper to enable interoperability between a native application and a framework application written in managed code. Business logic 201 includes logic for loading compiled managed code 202, logic for retrieving information about public APIs exposed in the compiled managed code 204, and logic for generating code to call the APIs in the compiled managed code 206. Business logic 201 also includes logic for generating marshaling code 208 and logic for outputting one or more files with the interop code 210.

In FIG. 2, business logic 201 is shown to reside on computer 110 as part of application programs 145. However, it will be understood that business logic 201 can alternatively or additionally be embodied as computer-executable instructions on one or more computers and/or in different variations than shown on FIG. 2. As one non-limiting example, one or more parts of business logic 201 could alternatively or additionally be implemented as an XML web service that resides on an external computer that is called when needed.

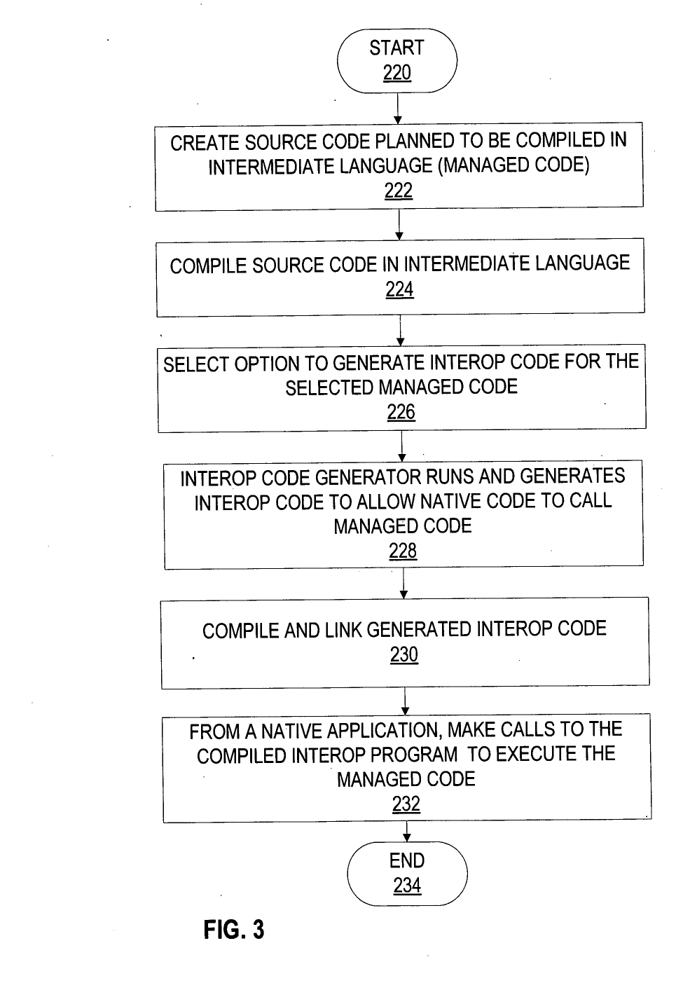

Turning now to FIGS. 3-6 with continued reference to FIGS. 1-2, the stages for implementing one or more aspects of interop code generator 200 of system 100 are described in further detail. FIG. 3 is a high level process flow diagram of one aspect of the current invention. In one form, the process of FIG. 3 is at least partially implemented in the operating logic of system 100. The process begins at start point 220 with creating the source code for the application that will be compiled in an intermediate language for management under a framework (stage 222). The source code is compiled in the intermediate language (stage 224). An option to generate interop code can be selected by a user or programmatically (stage 226). Upon receiving the selection, interop code generator 200 executes business logic 201 to generate the interop code to allow the native application to call the managed application that runs in the framework environment (stage 228). The interop code is then compiled and linked into an interop program (stage 230). The interop program is also referred to herein as a wrapper. A native application can then call the interop program so that it can execute the managed code of the framework application (stage 232). The process then ends at end point 234.

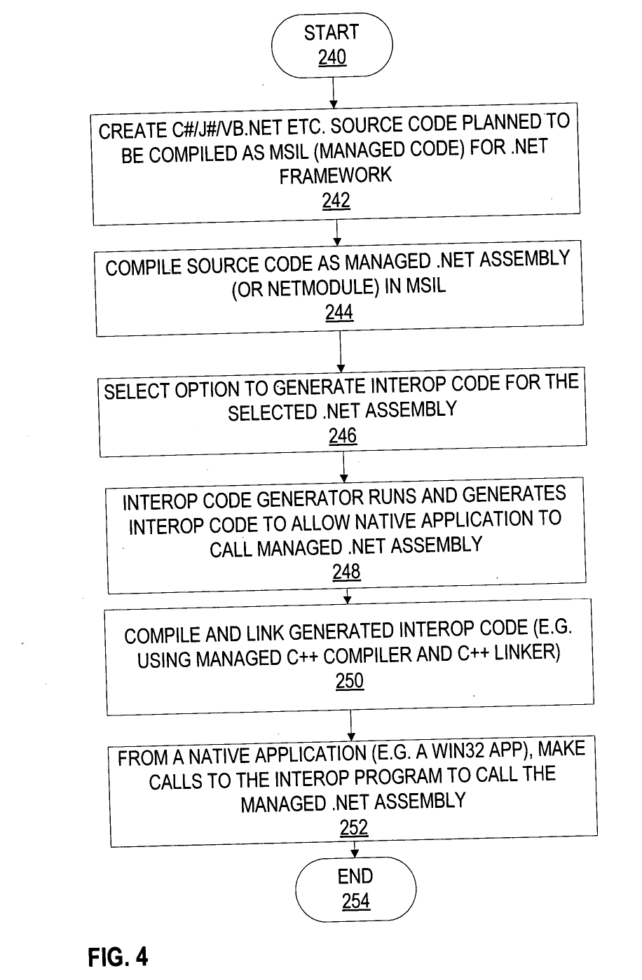

These stages will now be described in further detail in FIGS. 4-6 with specific reference to an exemplary operating environment that includes the MICROSOFT® .NET Framework. However, one of ordinary skill in the software art will appreciate that these examples are illustrative only, and that other operating environments and frameworks, such as those using a Java Virtual Machine, are also within the scope of the present invention.

FIG. 4 illustrates the stages involved in creating a wrapper for interoperability between a native application and a MICROSOFT® .NET application. In one form, the process of FIG. 4 is at least partially implemented in the operating logic of system 100. The process begins at start point 240 with the user creating the source code in a language supported by the MICROSOFT® .NET Framework, such as C#, J#, and/or Visual Basic .NET (stage 242). The source code is then compiled into one or more managed .NET assemblies or netmodules in the MICROSOFT® intermediate language (MSIL) (stage 244). An option to generate the interop code (wrapper) is selected by the user or programmatically (stage 246). The interop code generator 200 runs and generates the interop code to allow a native application to call the managed .NET assembly (stage 248). The interop code is then compiled and linked into an interop program (stage 250).

As one non-limiting example, the interop code is generated by interop code generator 200 in a C++ language syntax, is compiled using a managed C++ compiler provided by the MICROSOFT® .NET Framework, and is linked using a C++ linker. Other variations are also possible, as would occur to one of ordinary skill in the art. A native application, such as a Win32 application, can call the interop program that is managed under the MICROSOFT® .NET Framework in order to access the features implemented in the .NET assembly (stage 252). The process ends at end point 254.

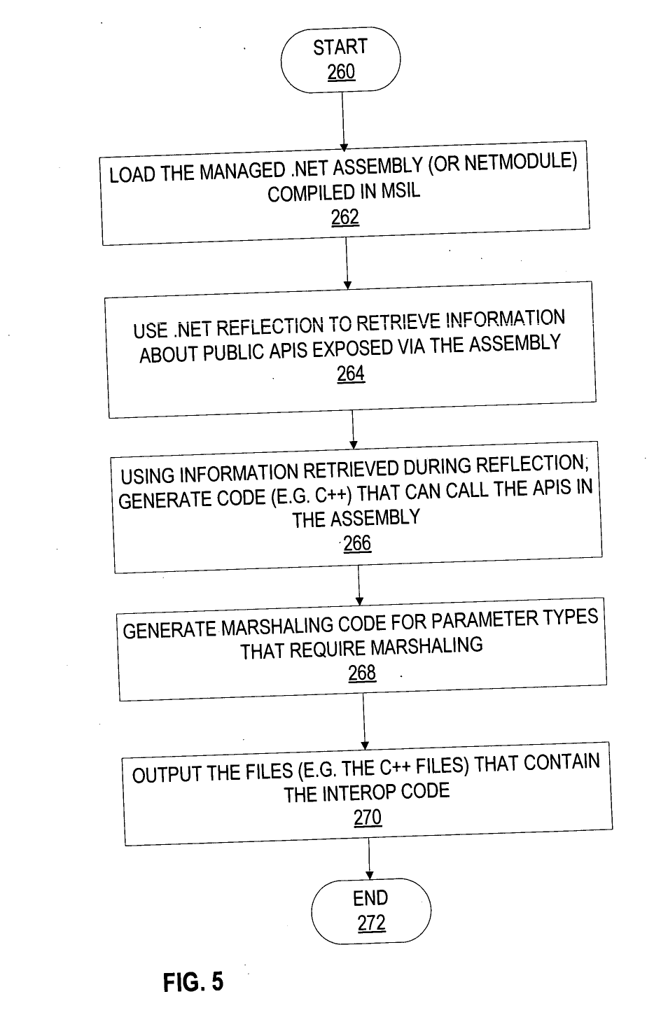

FIG. 5 illustrates the more detailed stages performed by the interop code generator as described in stage 248 of FIG. 4. In one form, the process of FIG. 5 is at least partially implemented in the operating logic of system 100. The process begins at start point 260 with interop code generator 200 executing business logic 202 for loading the managed .NET assembly (or netmodule) that has been compiled in MSIL (stage 262). Business logic 204 is executed and uses .NET reflection techniques for retrieving information about the one or more public APIs that are exposed via the assembly (stage 264). Alternatively or additionally, a list of the public APIs in the assembly can be presented to the user so the user can select which APIs to include in the interop program. Business logic 206 then executes to use the information retrieved during reflection to generate source code that can call the APIs in the assembly (stage 266). If any parameter types in the .NET assembly will need to be marshaled, then business logic 208 executes to generate the marshaling code for the parameter types that require marshaling (stage 268).

For example, marshaling is required when a parameter type in the .NET assembly does not have a direct correlation with a particular parameter type supported by a native application that will be communicating with the NET assembly. Therefore, the type used by the intermediate language must be converted to a type used by the native application that is a closest equivalent. As one non-limiting example, the System.Int32 type in the .NET assembly might be translated to _int32 in the generated interop code. As another non-limiting example, the System.IntPtr type in the .NET assembly might be translated to INT_PTR in the generated interop code. In one non-limiting example, marshaling code for complex structures can be recursively generated.

The following is a non-limiting example of how a public method of the assembly written in C# might be translated to C++ code by interop code generator 200.

The C# method:

public static System.IntPtr Method(System.String str)
{
}

After interop code generator 200 analyzes the above C# method, determines the proper type to use for marshaling, and translates the code to C++, the code might look similar to:

INT_PTR InterOpMethod(wchar_t*str, size_t strLen)

Business logic 210 then executes in order to output the one or more source code files generated during this process that contain the interop code (stage 270). The process then ends at end point 272.

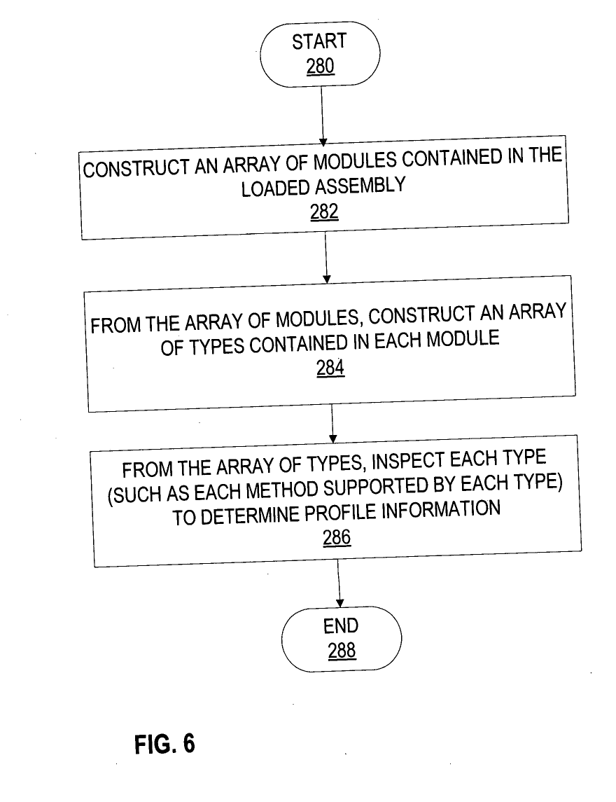

Turning now to FIG. 6, the stages involved in using a reflection procedure (stage 264 of FIG. 5) to retrieve information used by the interop code generator are described in further detail. In one form, the process of FIG. 6 is at least partially implemented in the operating logic of system 100. As one non-limiting example, the reflection stages described herein can be implemented using the reflection procedures provided by the MICROSOFT® .NET Framework, which allow programmatic access to information about .NET assemblies. Reflection procedures offered in other platforms and/or languages could also be used.

The process begins at start point 280 with constructing an array of modules contained in the loaded assembly (stage 282). From the array of modules, an array is constructed of the types that are contained in each module (stage 284). Then, from the array of types, each type is inspected to determine profile information that is used to generate the interop code (stage 286). As one non-limiting example, each method supported by each type is inspected to determine the profile information (stage 286). The process then ends at end point 288.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. All equivalents, changes, and modifications that come within the spirit of the inventions as described herein and/or by the following claims are desired to be protected.

For example, a person of ordinary skill in the computer software art will recognize that the client and/or server arrangements, user interface screen content, and/or data layouts as described in the examples discussed herein could be organized differently on one or more computers to include fewer or additional options or features than as portrayed in the examples and still be within the spirit of the invention.

What is claimed is:

1. A computer-readable medium having computer-executable instructions for causing a computer to perform steps comprising:
loading a managed program compiled in an intermediate language;
retrieving information about at least one public API exposed in the managed program;
generating source code to call the at least one public API using the retrieved information, the source code being operable to enable at least one native application to interact with the at least one public API in the managed program; and
outputting the source code into at least one source code file that can be compiled using a compiler.

2. The computer-readable medium of claim 1, wherein the generating source code step further comprises the step of:
generating marshaling code for any parameter types in the at least one public API that do not have a direct correlation with a particular parameter type supported by the native application and thus require translation from a first type used by the intermediate language to a second type used by the native application that is a closest equivalent to the first type.

3. The computer-readable medium of claim 1, further comprising the step of:
compiling and linking the source code.

4. The computer-readable medium of claim 3, wherein the compiling is performed by a managed C++ compiler and the linking is performed by a C++ linker.

5. The computer-readable medium of claim 1, wherein the retrieving information step further comprises the step of:
from the loaded managed program, constructing an array of modules contained in the managed program;
from the array of modules, constructing an array of types contained in each module; and
from the array of types, inspecting each type in the array of types to determine profile information.

6. The computer-readable medium of claim 5, wherein the inspecting each type step further comprises the step of:
recursively inspecting each method supported by each type in the array of types to determine profile information.

7. The computer-readable medium of claim 1, wherein the retrieving information step is performed at least in part by using a reflection procedure.

8. A method for generating a wrapper for interoperability between a native application and a framework environment comprising the steps of:
receiving a program selection from a user to select a particular program that has been compiled in an intermediate language;
receiving an interop selection option from a user to execute an interop code generator against the particular selected program;
upon receiving the interop selection option, running the interop code generator and generating an interop source code that will allow at least one native application to communicate with the selected program;
compiling and linking the generated interop source code into an interop program; and
from the native application, calling the interop program in order to communicate with the selected program.

9. The method of claim 8, wherein the steps are repeated for each of a plurality of programs that have been compiled in the intermediate language.

10. The method of claim 8, wherein the intermediate language is Microsoft intermediate language.

11. The method of claim 8, wherein a source code associated with the selected program was created using one or more of a plurality of languages supported by a Microsoft .NET framework.

12. The method of claim 8, wherein the interop source code is generated in a C++ language.

13. The method of claim 8, wherein the interop program is compiled using a managed C++ compiler.

14. The method of claim 8, wherein the interop program is linked using a C++ linker.

15. The method of claim 8, wherein the running the interop code generator and generating the interop source code step comprises the steps of:
loading the particular selected program into memory;
retrieving information about at least one public API exposed in the selected program;
using at least part of the retrieved information, generating the interop source code that will allow the at least one native application to communicate with the selected program; and
outputting at least one file containing the interop source code.

16. The method of claim 15, wherein the retrieving information step is performed at least in part using a reflection procedure.

17. The method of claim 15, wherein the retrieving information step comprises the steps of:
constructing an array of modules contained in the selected program;
from the array of modules, constructing an array of types contained in each module; and
from the array of types, inspecting each type in the array of types to determine profile information.

18. The method of claim 15, wherein the running the interop code generator and generating the interop source code step further comprises the step of:
prior to the outputting step, generating marshaling code for any parameter types in the at least one public API that do not have a direct correlation with a particular parameter type supported by the native application and thus require translation from a first type used by the intermediate language to a second type used by the native application that is a closest equivalent to the first type.

19. The method of claim 8, wherein the native application is a Win32 native application.

20. A computer-readable medium having computer-executable instructions for causing a computer to perform the steps recited in claim 8.
